(19) United States
(12) Patent Application Publication
(10) Pub. No.: US 2017/0286868 A1
(43) Pub. Date: Oct. 5, 2017

(54) PREFERENCE CLUSTERING USING DISTANCE AND ANGULAR MEASUREMENT

(71) Applicant: eBay Inc., San Jose, CA (US)

(72) Inventor: Romualdas Maslovskis, San Jose, CA (US)

(21) Appl. No.: 15/475,608

(22) Filed: Mar. 31, 2017

Related U.S. Application Data
(60) Provisional application No. 62/316,137, filed on Mar. 31, 2016.

(51) Int. Cl. G06N 99/00; G06F 17/18; G06F 7/548; G06F 17/16

(52) U.S. Cl. CPC G06N 99/005; G06F 17/16; G06F 17/18; G06F 7/548

(57) ABSTRACT

Systems methods and media for preference clustering are provided. In one example, a clustering system for analyzing a cluster comprises processors and a memory storing instructions that cause the system to calculate a Distance Angular Measure (DAM) for the cluster, the (DAM) comprising a distance component and an angular component of the cluster. In one example, the distance component of the (DAM) includes one of a cluster variation and a cluster radius.

### CLAIM OF PRIORITY

This patent application claims the benefit of priority, under 35 U.S.C. Section 119(e), to U.S. Provisional Patent Application Ser. No. 62/316,137, entitled “PREFERENCE CLUSTERING USING DISTANCE ANGULAR MEASURE,” filed on Mar. 31, 2016, which is hereby incorporated by reference herein in its entirety.

### TECHNICAL FIELD

This disclosure pertains generally to preference clustering using distance and angular measurement, and in some examples to specific clustering algorithms including a Distance Angular Measure, or (DAM).

### BACKGROUND

Cluster analysis comprises a set of statistical techniques that aim to group objects into homogeneous subsets. The objects can be people or products. For example, cluster analysis can be used to segment consumers into subsets based on their preferences for a set of products. Such consumer segmentation might be used for providing personalized offers based on group preferences. Cluster analysis can also be used to cluster products instead of consumers to identify groups of similar products, for example to identify a group of related products. There are two common types of conventional clustering methods: partitioning methods and hierarchical methods.

In the partitioning approach, most commonly, the researcher must first specify the number of clusters that he or she is interested in. Objects are initially assigned to clusters on a random basis or on the basis of some prior knowledge or analysis. Using an iterative algorithm, a clustering program reassigns each object to clusters until no further improvement in within-cluster homogeneity is achieved. The analysis is repeated for different numbers of clusters of interest to the researcher. An algorithm known as K-means is a widely used partitioning algorithm.

One of the technical challenges in identifying clusters such as a group of consumers (or products) is identifying how ‘close’ consumers are to each other, or how far apart they are. Two consumers are ‘close’ when their dissimilarity or distance is small or their similarity is large. There are different proximity measures for different types of data, for example categorical data, continuous data or a mix of the two.

The most widely used proximity measures for continuous data include the:

### Minkowski Distance

$$d ( \vec{x} \vec{y} ) = {( {\sum }_{i} {\vert {x}_{i} - {y}_{i} \vert}^{p} )}^{( \frac{1}{p} )} , p \geq 1 \qquad ( 1 )$$

Minkowski distance is typically used with p equal 1 or 2, and

### The Cosine Similarity

$${δ}_{\vec{x} \vec{y}} = \frac{〈 \vec{x} , \vec{y} 〉}{‖ \vec{x} ‖ ‖ \vec{y} ‖} = \frac{{\sum }_{i} {x}_{i} {y}_{i}}{{( {\sum }_{i} {x}_{i}^{2} {\sum }_{i} {y}_{i}^{2} )}^{\frac{1}{2}}} \qquad ( 2 )$$

### BRIEF DESCRIPTION OF THE DRAWINGS

In order more easily to identify the discussion of any particular element or act, the most significant digit or digits in a reference number refer to the figure number in which that element is first introduced.

FIG. 1 is a block diagram illustrating a networked system in accordance with an example embodiment.

FIG. 2 is a block diagram illustrating components of a machine, in accordance with some example embodiments, able to read instructions from a machine-readable medium (e.g., a machine-readable storage medium) and to perform any one or more of the methodologies discussed herein.

FIG. 3 is a block diagram illustrating a representative software architecture which may be used in conjunction with various hardware architectures herein described.

FIGS. 4A and 4B illustrate comparative aspects of the subject matter in accordance with some embodiments.

FIGS. 5A and 5B illustrate further comparative aspects of the subject matter in accordance with some embodiments.

FIG. 6 illustrates a flow chart of a method for analyzing a cluster in accordance with an example embodiment.

### DETAILED DESCRIPTION

“CARRIER MEDIUM” in this context refers to any tangible and intangible medium that is capable of storing, encoding, or carrying instructions for execution by the machine, and includes a carrier signal and a machine-readable medium.

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra-books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to logic having boundaries defined by function or subroutine calls, branch points, application program interfaces (APIs), or other technologies that provide for the partitioning or modularization of particular processing or control functions. Components are typically combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated. Circuit (RTIC) or any combination thereof. A processor may further be a multi-core processor having two or more independent processors (sometimes referred to as “cores”) that may execute instructions contemporaneously.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2016, eBay Inc., All Rights Reserved.

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

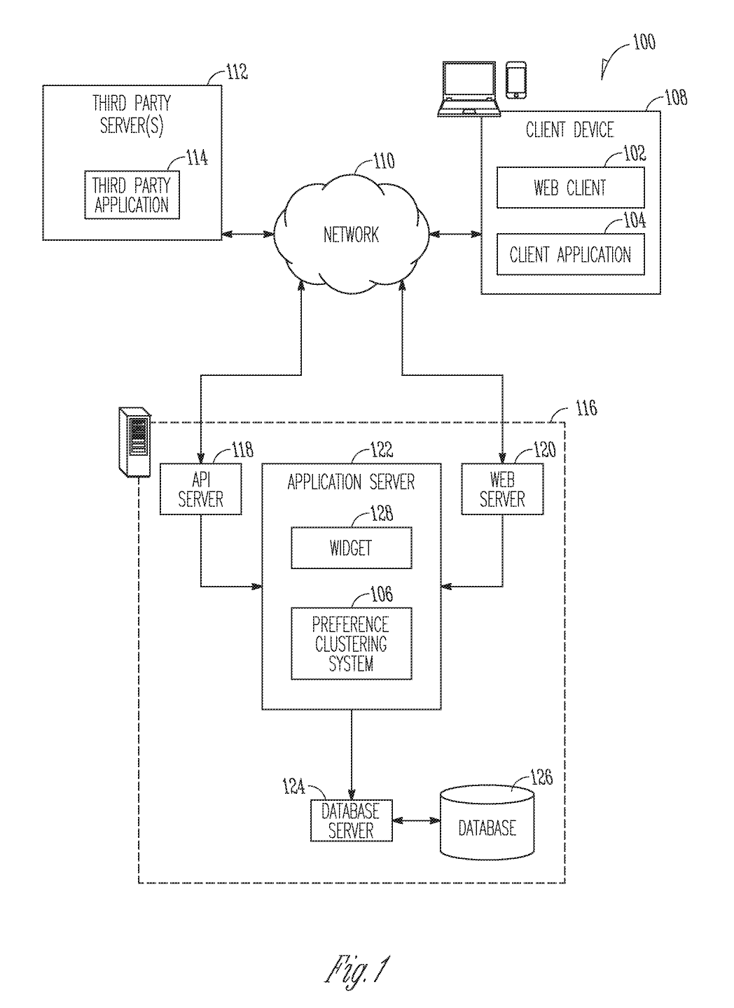

With reference to FIG. 1, an example embodiment of a high-level SaaS network architecture 100 is shown. A networked system 116 provides server-side functionality via a network 110 (e.g., the Internet or wide area network (WAN)) to a client device 108. A web client 102 and a programmatic client, in the example form of an application 104 are hosted and execute on the client device 108. The networked system 116 includes an application server 122 which in turn hosts a preference clustering system 106 that provides a number of functions and services to the application 104 that accesses the networked system 116. The application 104 also provides a number of interfaces described herein, which present output of the tracking and analysis operations to a user of the client device 108.

The client device 108 enables a user to access and interact with the networked system 116. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An Application Program Interface (API) server 118 and a web server 120 are coupled to, and provide programmatic and web interfaces respectively, to the application server 122. The application server 122 hosts a preference clustering system 106, which includes components or applications. The application server 122 is, in turn, shown to be coupled to a database server 124 that facilitates access to information storage repositories (e.g., a database 126). In an example embodiment, the database 126 includes storage devices that store information accessed and generated by the preference clustering system 106.

Additionally, a third party application 114, executing on a third party server 112, is shown as having programmatic access to the networked system 116 via the programmatic interface provided by the Application Program Interface (API) server 118. For example, the third party application 114, using information retrieved from the networked system 116, may support one or more features or functions on a website hosted by the third party.

Turning now specifically to the applications hosted by the client device 108, the web client 102 may access the various systems (e.g., preference clustering system 106) via the web interface supported by the web server 120. Similarly, the application 104 (e.g., an “app”) accesses the various services and functions provided by the preference clustering system 106 via the programmatic interface provided by the Application Program Interface (API) server 118. The application 104 may, for example, an “app” executing on a client device 108, such as an iOS or Android OS application to enable user to access and input data on the networked system 116 in an off-line manner, and to perform batch-mode communications between the programmatic client application 104 and the networked system networked system 116.

Further, while the SaaS network architecture 100 shown in FIG. 1 employs a client-server architecture, the present inventive subject matter is of course not limited to such an architecture, and could equally well find application in a distributed, or peer-to-peer, architecture system, for example. The preference clustering system 106 could also be implemented as a standalone software program, which do not necessarily have networking capabilities.

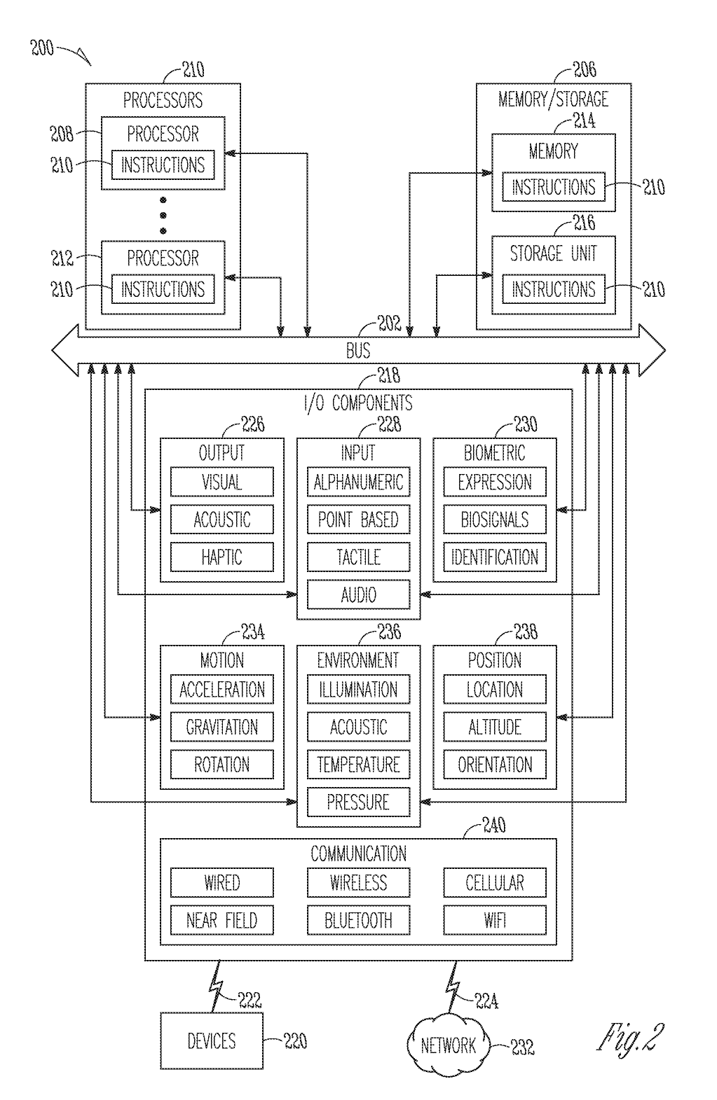

FIG. 2 is a block diagram illustrating components of a machine 200, according to some example embodiments, able to read instructions from a machine-readable medium (e.g., a machine-readable storage medium) and perform any one or more of the methodologies discussed herein. Specifically, FIG. 2 shows a diagrammatic representation of the machine 200 in the example form of a computer system, within which instructions 210 (e.g., software, a program, an application, an apples, an app, or other executable code) for causing the machine 200 to perform any one or more of the methodologies discussed herein may be executed. As such, the instructions may be used to implement components or components described herein. The instructions transform the general, non-programmed machine into a particular machine programmed to carry out the described and illustrated functions in the manner described. In alternative embodiments, the machine 200 operates as a standalone device or may be coupled (e.g., networked) to other machines. In a networked deployment, the machine 200 may operate in the capacity of a server machine or a client machine in a server-client network environment, or as a peer machine in a peer-to-peer (or distributed) network environment. The machine 200 may comprise, but not be limited to, a server computer, a client computer, a personal computer (PC), a tablet computer, a laptop computer, a netbook, a set-top box (SIB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 210, sequentially or otherwise, that specify actions to be taken by machine 200. Further, while only a single machine 200 is illustrated, the term “machine” shall also be taken to include a collection of machines that individually or jointly execute the instructions 210 to perform any one or more of the methodologies discussed herein.

The machine 200 may include processors 204, memory memory/storage 206, and I/O components 218, which may be configured to communicate with each other such as via a bus 202. The memory/storage 206 may include a memory 214, such as a main memory, or other memory storage, and a storage unit 216, both accessible to the processors 204 such as via the bus 202. The storage unit 216 and memory 214 store the instructions 210 embodying any one or more of the methodologies or functions described herein. The instructions 210 may also reside, completely or partially, within the memory 214, within the storage unit 216, within at least one of the processors 204 (e.g., within the processor's cache memory), or any suitable combination thereof, during execution thereof by the machine 200. Accordingly, the memory 214, the storage unit 216, and the memory of processors 204 are examples of machine-readable media.

The I/O components 218 may include a wide variety of components to receive input, provide output, produce output, transmit information, exchange information, capture measurements, and so on. The specific I/O components 218 that are included in a particular machine will depend on the type of machine. For example, portable machines such as mobile phones will likely include a touch input device or other such input mechanisms, while a headless server machine will likely not include such a touch input device. It will be appreciated that the I/O components 218 may include many other components that are not shown in FIG. 2. The I/O components 218 are grouped according to functionality merely for simplifying the following discussion and the grouping is in no way limiting. In various example embodiments, the I/O components 218 may include output components output components 226 and input components 228. The output components 226 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 228 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 218 may include biometric components 230, motion components 234, environmental environment components 236, or position components 238 among a wide array of other components. For example, the biometric components 230 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 234 may include acceleration sensor components accelerometer), gravitation sensor components, rotation sensor components (e.g., gyroscope), and so forth. The environment components 236 may include, for example, illumination sensor components (e.g., photometer), temperature sensor components one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 238 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 218 may include communication components 240 operable to couple the machine 200 to a network 232 or devices 220 via coupling 222 and coupling 224 respectively. For example, the communication components 240 may include a network interface component or other suitable device to interface with the network 232. In further examples, communication components 240 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 220 may be another machine or any of a wide variety of peripheral devices (e.g., a peripheral device coupled via a Universal Serial Bus (USB)).

Moreover, the communication components 240 may detect identifiers or include components operable to detect identifiers. For example, the communication components processors communication components 240 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code. Data Matrix, Dataglyph, PDF417, Ultra Code, UCC RSS-2D bar code, and other optical codes), or acoustic detection components (e.g., microphones to identify tagged audio signals). In addition, a variety of information may be derived via the communication components 240, such as, location via Internet Protocol (IP) geo-location, location via Wi-Fi® signal triangulation, location via detecting a NFC beacon signal that may indicate a particular location, and so forth.

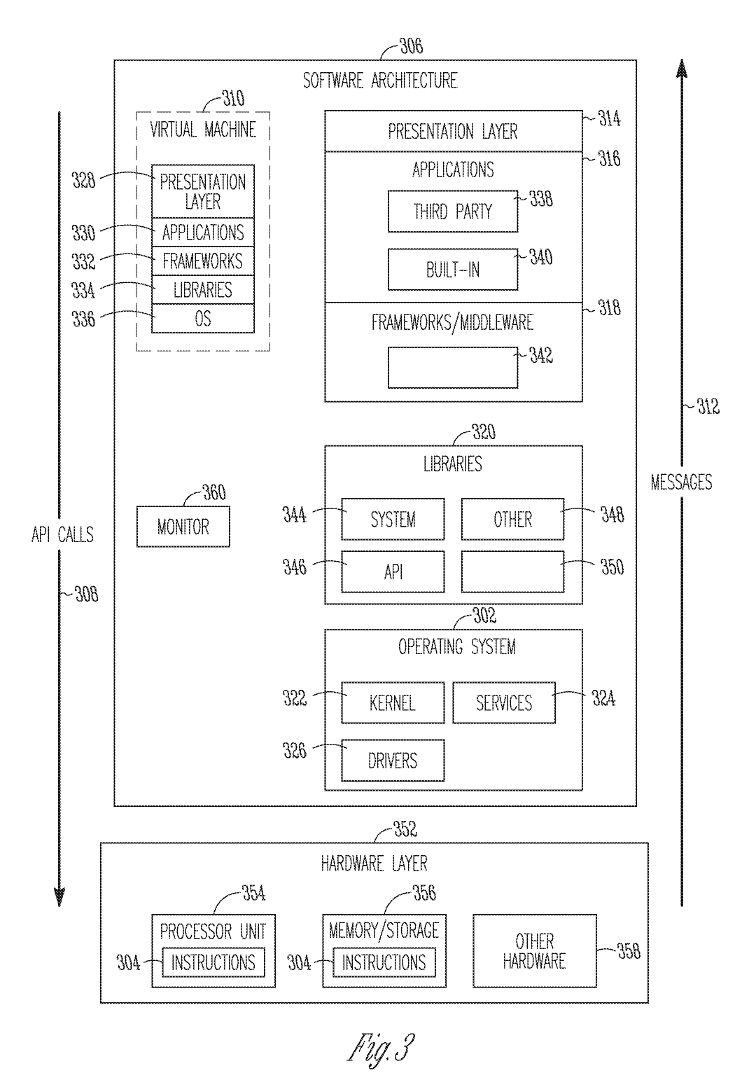

FIG. 3 is a block diagram illustrating an example software architecture 306, which may be used in conjunction with various hardware architectures herein described. FIG. 3 is a non-limiting example of a software architecture and it will be appreciated that many other architectures may be implemented to facilitate the functionality described herein. The software architecture 306 may execute on hardware such as machine 200 of FIG. 2 that includes, among other things, processors 204, memory 214, and I/O components 218. A representative hardware layer 352 is illustrated and can represent, for example, the machine 200 of FIG. 2. The representative hardware layer 352 includes a processing unit 354 having associated executable instructions 304. Executable instructions 304 represent the executable instructions of the software architecture 306, including implementation of the methods, components and so forth described herein. The hardware layer 352 also includes memory and/or storage components memory/storage 356, which also have executable instructions 304, The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, applications 316 and a presentation layer 314. Operationally, the applications 316 and/or other components within the layers may invoke application programming interface (API) API calls 308 through the software stack and receive a response as in response to the API calls 308. The layers illustrated are representative in nature and not all software architectures have all layers. For example, some mobile or special purpose operating systems may not provide a frameworks/middleware 318, while others may provide such a layer, Other software architectures may include additional or different layers.

The operating system 302 may manage hardware resources and provide common services. The operating system 302 may include, for example, a kernel 322, services 324 and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than to interface directly with the underlying operating system 302 functionality (e.g., kernel 322, services 324 and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/components.

The frameworks frameworks/middleware 318 (also sometimes referred to as middleware) provide a higher-level common infrastructure that may be used by the applications 316 and/or other software components/components. For example, the frameworks/middleware 318 may provide various graphic user interface (GUI) functions, high-level resource management, high-level location services, and so forth. The frameworks/middleware 318 may provide a broad spectrum of other APIs that may be utilized by the applications 316 and/or other software components/components, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, and/or a game application. Third-party applications 340 may include any an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 340 may invoke the API calls 308 provided by the mobile operating system (such as operating system 302) to facilitate functionality described herein.

The applications 316 may use built in operating system functions (e.g., kernel 322, services 324 and/or drivers 326), libraries 320, and frameworks/middleware 318 to create user interfaces to interact with users of the system. Alternatively, or additionally, in some systems interactions with a user may occur through a presentation layer, such as presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 200 of FIG. 2, for example). The virtual machine 310 is hosted by a host operating system (operating system (OS) 336 in FIG. 3) and typically, although not always, has a virtual machine monitor 360, which manages the operation of the virtual machine as well as the interface with the host operating system (i.e., operating system 302). A software architecture executes within the virtual machine 310 such as an operating system operating system (OS) 336, libraries 334, frameworks 332, applications 330 and/or presentation layer 328. These layers of software architecture executing within the virtual machine 310 can be the same as corresponding layers previously described or may be different.

In one example, clustering or proximity measures can be applied to consumer preference grouping. Other examples or applications of this approach are possible.

One of the challenges of applying clustering algorithms is making an appropriate proximity measure selection. Depending on the shape of the clusters in question, different proximity measures can be used. One of the approaches to choose a proximity measure is to visually analyze the shape of the possible clusters. That might be done in a so-called d≦3 space explained further below.

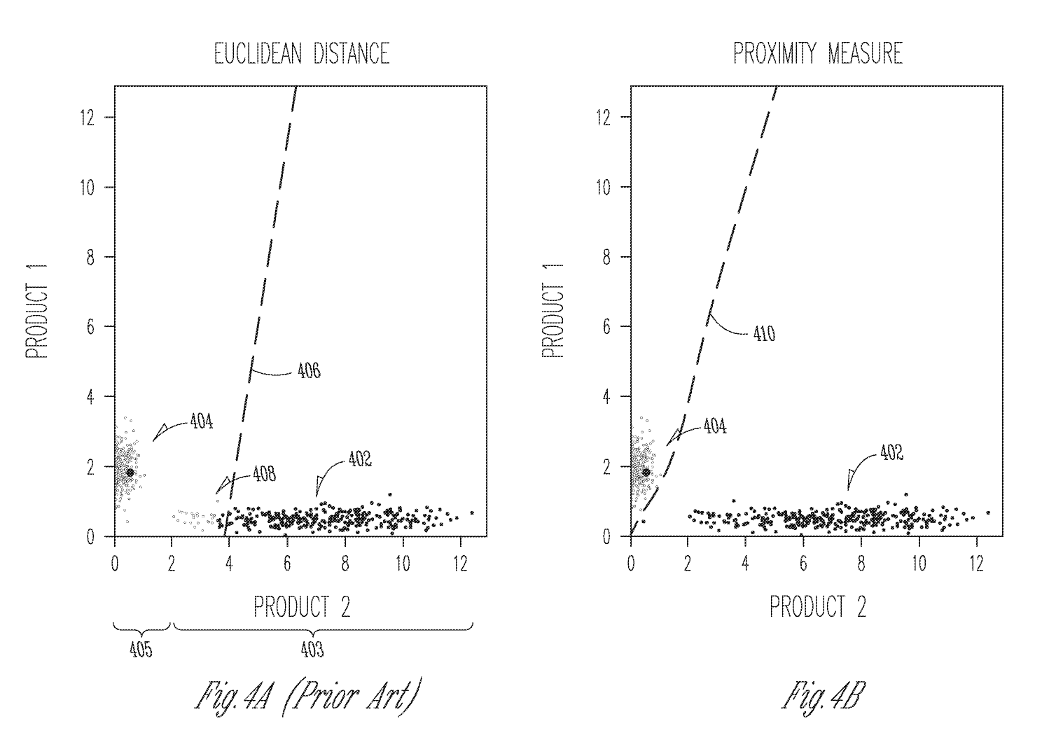

Suppose a goal is cluster two groups of consumers in an R² product space. Each axis in R² represents consumer preference in some products or a group of products. With reference to FIGS. 4A-4B, each group of consumers (shown by clusters of dots) has a strong preference for one of the products (or product features) associated with that cluster grouping, but one group's interest has high variation. Thus, a first group of consumers 402 may be said to have a “strong preference with high variance” (403) in a Product 1 (as an example) while a second group of consumers 404 has a “strong preference with low variance” (405) in another Product 2 (for example).

Application of conventional Euclidean distance measurement to the described problem as shown by line 406 in FIG. 4A might lead to misclassification at region 408 (to the left of line 406) of some members of the high variability group 402. That is seen in FIG. 4A. Part of group's members with strong preference in Product 1 were wrongly assigned to the group with preference in Product 2. Application of the present proximity measurement, described further below, does not result in such misclassification as shown by line 410 in FIG. 4B.

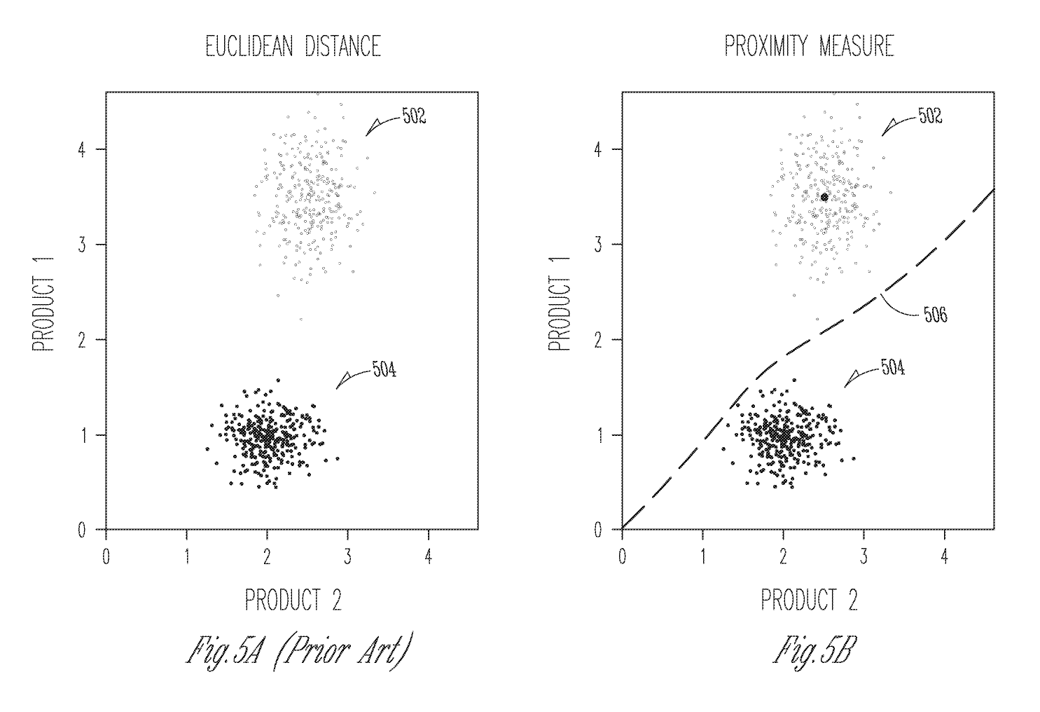

The problem described above might potentially be solved by using a cosine similarity measure, but a cosine similarity measure can also fall short particularly in cases where groups of consumers can't be separated by preferences in one of the products (features) or group of products, for example as shown in FIGS. 5A-5B. In FIG. 5A, consumer groups 502 and 504 can be separated by preferences to Product (or feature) 1, but not by preference to Product 2. Applying the cosine similarity measure may cause consumers from the “Product 2” cluster to be misclassified as the members of the “Product 1” cluster, and vice versa. The clusters 502 and 504 are classified separately as shown at curved line 506 in FIG. 5B using the techniques of the present application.

A new proximity measure which can address the limitations of Minkowski distance measures and the cosine similarity in consumer preference grouping is described below.

A “Distance Angular Measure”, hereinafter (DAM) is defined in R^{d} and a first quadrant where d>1 as:

$${δ}_{\vec{x} \vec{y}} = \frac{d ( \vec{x} , \vec{y} )}{ϕ ( \vec{x} , \vec{y} )} ( 1 - cos ( \vec{x} , \vec{y} ) ) \qquad ( 3 )$$

where \vec{x},\vec{y}εR₊^{d}, d(\vec{x},\vec{y}) is some distance function, for instance, the Minkowski distance function. ρ(\vec{x},\vec{y})>0—as a normalizing function. If one measures, for instance, a distance from a cluster center to some point then the possible normalization functions could be:
1. A cluster variation

$${σ}_{{C}_{j}}^{2} = {\sum }_{\vec{x} ∈ {C}_{j}} \frac{‖ \vec{x} - {\vec{c}}_{j} ‖}{{N}_{{C}_{j}}} ,$$

where \vec{c}ⱼ is a center of the cluster Cⱼ,\vec{x}εCⱼ and N_{C}_{ⱼ} is a number of observations or points in Cⱼ, or
2. A cluster radius φ_{C}_{ⱼ}=max_{\vec{x}εC}_{ⱼ}d(\vec{x},\vec{c}ⱼ). If one measures the closeness between two points, then:

ρ(\vec{x},\vec{y})=\sqrt{∥\vec{x}∥+∥\vec{y}∥} 1.

In some examples, (DAM) comprises two components: namely (1) a distance component (distance measure and normalized function), and (2) an angular component (cosine function).

Some properties of (DAM) can include:

1. Non-negativity. δ_{\vec{x}\vec{y}}≧0, (DAM) is non-negative for all \vec{x},\vec{y}εR₊^{d} it comes from definition of (DAM). d(\vec{x},\vec{y})≧0 by definition, ρ(\hat{x},\vec{y}) defined as positive not equal 0. (DAM) is defined in first quadrant, thus cos(\vec{x},\vec{y}) takes values from interval [0,1]. This leads to non-negative values of angular component of (DAM).

2. Symmetry. δ_{\vec{x}\vec{y}}=δ_{\vec{y}\vec{z}}

3. (DAM) has a pseudo-metric property: δ_{\vec{x}\vec{y}}=0 not only if \vec{x}=\vec{y}

The results of the application of (DAM) to the cluster analysis examples discussed above with reference to FIGS. 4B and 5B can be compared with the inferior results obtained by application of conventional Euclidean distance and cosine similarity techniques as shown in FIGS. 4A and 5A, respectively. In other examples, consumers can be clustered by preference using (DAM). An example algorithm can be divided into two parts, for example construction of a new product or category space, and consumers grouping according to new segments.

Thus, in one example, a clustering system for analyzing a cluster comprises processors, and a memory storing instructions that, when executed by at least one processor among the processors, cause the system to perform operations comprising, at least: calculating a Distance Angular Measure (DAM) for the cluster, the (DAM) comprising a distance component and an angular component of the cluster.

In some examples, the distance component of the (DAM) may include one of a cluster variation and a cluster radius. The cluster variation may be defined by an algorithm comprising:

$${σ}_{{C}_{j}}^{2} = {\sum }_{\vec{x} ∈ {C}_{j}} \frac{‖ \vec{x} - {\vec{c}}_{j} ‖}{{N}_{{C}_{j}}} ,$$

where \vec{c}ⱼ is a center of the cluster Cⱼ,\vec{x}εCⱼ and N_{C}_{ⱼ} is a number of observations or points in Cⱼ.

In some examples, the cluster radius may be defined by an algorithm comprising:

φ_{C}_{ⱼ}=max_{\vec{x}εC}_{ⱼ}d(\vec{x},\vec{c}ⱼ)

In some examples, a distance between two points in the cluster may be defined by an algorithm comprising:

ρ(\vec{x},\vec{y})=\sqrt{∥\vec{x}∥+∥\vec{y}∥} 1.

In some examples, the angular component of the (DAM) may include a cosine function.

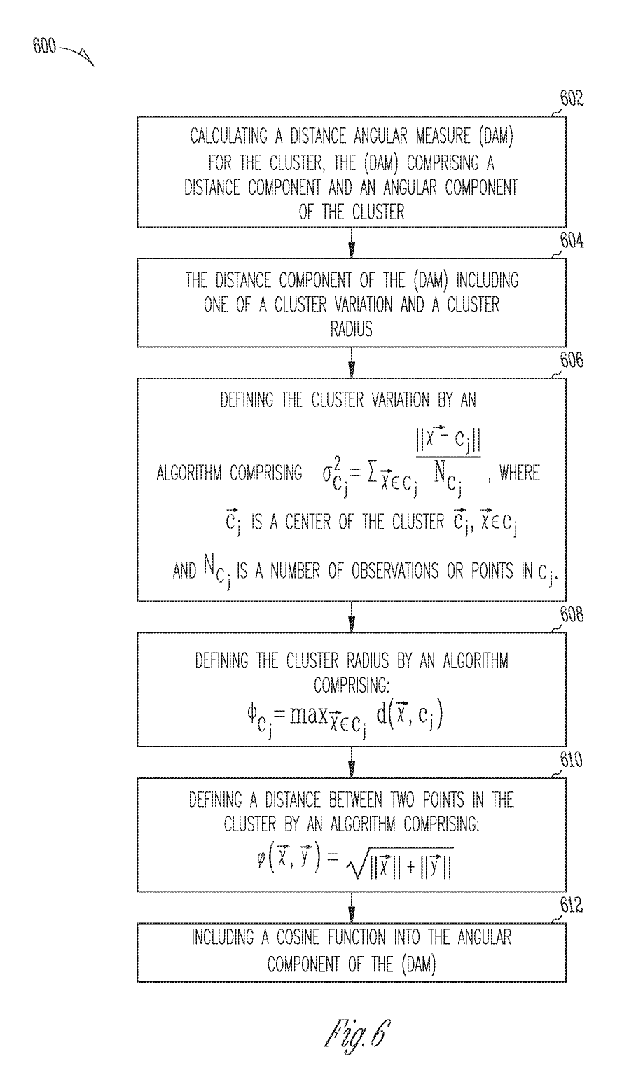

Aspects of the present disclosure also include method embodiments. With reference to FIG. 6, a method 600 for analyzing a cluster comprises, at 602, calculating a Distance Angular Measure (DAM) for the cluster, the (DAM) comprising a distance component and an angular component of the cluster. The distance component of the (DAM) may, at 604, include one of a cluster variation and a cluster radius. The method 600 may include at 606 defining the cluster variation by an algorithm comprising:

$${σ}_{{C}_{j}}^{2} = {\sum }_{\vec{x} ∈ {C}_{j}} \frac{‖ \vec{x} - {\vec{c}}_{j} ‖}{{N}_{{C}_{j}}} ,$$

where \vec{c}ⱼ is a center of the cluster, Cⱼ,\vec{x}εCⱼ and N_{C}_{ⱼ} is a number of observations or points in Cⱼ. The method 600 may include at 608 defining the cluster radius by an algorithm comprising:

φcⱼ=max_{\vec{x}εC}_{ⱼ}d(\vec{x},\vec{c}ⱼ)

In some examples, the method 600 may further comprise at 610 defining a distance between two points in the cluster by an algorithm comprising:

ρ(\vec{x},\vec{y})=\sqrt{∥\vec{x}∥+∥\vec{y}∥} 1.

In some examples, the method 600 further comprises at 612 including a cosine function into the angular component of the (DAM)

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent those of skill in the art upon reviewing the above description.

1. A clustering system for analyzing a cluster, the clustering system comprising:
processors; and
a memory storing instructions that, when executed by at least one processor among the processors, cause the system to perform operations comprising, at least:
calculating a Distance Angular Measure (DAM) for the cluster, the (DAM) comprising a distance component and an angular component of the cluster.

2. The clustering system of claim 1, wherein the distance component of the (DAM) includes one of a cluster variation and a cluster radius.

3. The clustering system of claim 2, wherein the cluster variation is defined by an algorithm comprising:
$${σ}_{{C}_{j}}^{2} = {\sum }_{\vec{x} ∈ {C}_{j}} \frac{‖ \vec{x} - {\vec{c}}_{j} ‖}{{N}_{{C}_{j}}} ,$$
where \vec{c}ⱼ is a center of the cluster Cⱼ,\vec{x}εCⱼ and N_{C}_{ⱼ} is a number of observations or points in Cⱼ.

4. The clustering system of claim 2, wherein the cluster radius is defined by an algorithm comprising:
φ_{C}_{ⱼ}=max_{\vec{x}εC}_{ⱼ}d(\vec{x},\vec{c}ⱼ)

5. The clustering system of claim 4, wherein a distance between two points in the cluster is defined by an algorithm comprising:
ρ(\vec{x},\vec{y})=\sqrt{∥\vec{x}∥+∥\vec{y}∥} 1.

6. The clustering system of claim 1, wherein the angular component of the (DAM) includes a cosine function.

7. A method for analyzing a cluster, the method comprising:
calculating a Distance Angular Measure (DAM) for the cluster, the (DAM) comprising a distance component and an angular component of the cluster.

8. The method of claim 7, wherein the distance component of the (DAM) includes one of a cluster variation and a cluster radius.

9. The method of claim 8, further comprising defining the cluster variation by an algorithm comprising:
$${σ}_{{C}_{j}}^{2} = {\sum }_{\vec{x} ∈ {C}_{j}} \frac{‖ \vec{x} - {\vec{c}}_{j} ‖}{{N}_{{C}_{j}}} ,$$
where \vec{c}ⱼ is a center of the cluster Cⱼ,\vec{x}εCⱼ and N_{C}_{ⱼ} is a number of observations or points in Cⱼ.

10. The method of claim 8, further comprising defining the cluster radius by an algorithm comprising:
φ_{C}_{ⱼ}=max_{\vec{x}εC}_{ⱼ}d(\vec{x},\vec{c}ⱼ)

11. The method of claim 10, further comprising defining a distance between two points in the duster by an algorithm comprising:
φ(\vec{x},\vec{y})=\sqrt{∥\vec{x}∥+∥\vec{y}∥} 1.

12. The method of claim 7, further comprising including a cosine function into the angular component of the (DAM)

13. A machine-readable medium carrying instructions which, when read by a machine, cause the machine to perform operations comprising, at least:
calculating a Distance Angular Measure (DAM) for the cluster, the (DAM) comprising a distance component and an angular component of the cluster.

14. The medium of claim 13, wherein the distance component of the (DAM) includes one of a cluster variation and a cluster radius.

15. The medium of claim 14, wherein the cluster variation is defined by an algorithm comprising:
$${σ}_{{C}_{j}}^{2} = {\sum }_{\vec{x} ∈ {C}_{j}} \frac{‖ \vec{x} - {\vec{c}}_{j} ‖}{{N}_{{C}_{j}}} ,$$
where \vec{c}ⱼ is a center of the cluster Cⱼ,\vec{x}εCⱼ and N_{C}_{ⱼ} is a number of observations or points in Cⱼ.

16. The medium of claim 14, wherein the cluster radius is defined by an algorithm comprising:
φ_{C}_{ⱼ}=max_{\vec{x}εC}_{ⱼ}d(\vec{x},\vec{c}ⱼ)

17. The medium of claim 16, wherein a distance between two points in the cluster is defined by an algorithm comprising:
φ(\vec{x},\vec{y})=\sqrt{∥\vec{x}∥+∥\vec{y}∥} 1.

18. The medium of claim 13, wherein the angular component of the (DAM) includes a cosine function.
